(19) United States
(12) Patent Application Publication
(10) Pub. No.: US 2026/0235813 A1
(43) Pub. Date: Aug. 13, 2026

(54) SYSTEMS AND METHODS FOR MULTIPLEXING AND TRANSMISSION OF HIGH ENERGY LIGHT VIA ANTIRESONANT HOLLOW CORE DELIVERY FIBER

(71) Applicant: University of Central Florida Research Foundation, Inc., Orlando, FL (US)

(72) Inventors: Matthew Cooper, Orlando, FL (US); Rodrigo Amezcua-Correa, Orlando, FL (US); Axel Schülzgen, Orlando, FL (US); Jose Enrique Antonio-Lopez, Orlando, FL (US); Stephanos Yerolatsitis, Orlando, FL (US); Joseph Wahlen, Orlando, FL (US)

(21) Appl. No.: 19/153,540

(22) PCT Filed: Feb. 5, 2024
(86) PCT No.: PCT/US2024/014499

§ 371 Date: Aug. 4, 2025

Related U.S. Application Data
(60) Provisional application No. 63/443,238, filed on Feb. 3, 2023.

(51) Int. Cl. G02B 6/293; G02B 6/02

(52) U.S. Cl. CPC G02B 6/2938; G02B 6/02328

(57) ABSTRACT

A system may include a first light source configured to generate a first light beam, where the first light beam is a pulsed light beam, where the first light beam is guided as a single transverse mode beam. A system may include a second light source configured to generate a second light beam, where the second light beam is a continuous-wave light beam. A system may include a hollow core optical fiber configured to propagate the first and second light beams. A system may include one or more optical elements to couple the first and second beams into the hollow core fiber.

### CROSS-REFERENCE TO RELATED APPLICATION

The present application is a national phase entry under 35 U.S.C. § 371 of the Patent Cooperation Treaty number PCT/US24/14499, filed Feb. 5, 2024, which is incorporated herein by reference in the entirety, which claims the benefit under 35 U.S.C. § 119 (e) of U.S. Provisional Application Ser. No. 63/443,238, filed Feb. 3, 2023, which is incorporated herein by reference in their entireties.

### GOVERNMENT SUPPORT

This invention was made with government support under Grant Number W911NF1910426 awarded by the Army Research Office (ARO). The government has certain rights in the invention.

### TECHNICAL FIELD

The present disclosure generally relates to laser systems and, more particularly, laser systems including an antiresonant hollow core delivery fiber.

### BACKGROUND

Many applications may benefit from the selective or simultaneous use of laser energy having different properties such as, but not limited to, a combination of wavelength, pulse duration, power, intensity, or the like, which may be generated the same or different laser sources. However, typical laser systems utilize dedicated beam delivery systems tailored for the properties of the laser light to be delivered. As a result, selective or simultaneous use of laser energy with different properties typically requires the use of separate beam delivery systems, which may result in undesirable complexity or cost. There is therefore a need to develop systems and methods to cure the above deficiencies.

### SUMMARY

In embodiments, the techniques described herein relate to a system including a first light source configured to generate a first light beam, where the first light beam is a pulsed light beam, where the first light beam is guided as a single transverse mode beam; a second light source configured to generate a second light beam, where the second light beam is a continuous-wave light beam; a hollow core fiber configured to propagate the first and second light beams; and one or more optical elements to couple the first and second beams into the hollow core fiber.

In embodiments, the techniques described herein relate to a system, where at least one of the first or second light beams includes a laser beam.

In embodiments, the techniques described herein relate to a system, where the hollow core optical fiber is configured to guide at least the second light beam as a single transverse mode beam.

In embodiments, the techniques described herein relate to a system, where the first light beam has a power greater than approximately 10 W.

In embodiments, the techniques described herein relate to a system, where the first light beam has a power greater than approximately 500 W.

In embodiments, the techniques described herein relate to a system, where the first light beam has a power greater than approximately 1000 W.

In embodiments, the techniques described herein relate to a system, where the first and second light beams have overlapping spectra.

In embodiments, the techniques described herein relate to a system, where the first and second light beams have wavelengths within a common transmission window of the hollow core fiber.

In embodiments, the techniques described herein relate to a system, where the first and second light beams have different spectra.

In embodiments, the techniques described herein relate to a system, where the first light beam has wavelengths within a first transmission window of the hollow core fiber, where the second light beam has wavelengths with a second transmission window of the hollow core fiber.

In embodiments, the techniques described herein relate to a system, where the first light beam includes one or more pulses with a duration less than approximately one microsecond.

In embodiments, the techniques described herein relate to a system, where the first light beam includes one or more pulses with a duration less than approximately one nanosecond.

In embodiments, the techniques described herein relate to a system, where the first light beam includes one or more pulses with a duration less than approximately one picosecond.

In embodiments, the techniques described herein relate to a method including designing a hollow core fiber to guide a first light beam and a second light beam via optical antiresonance, where the first light beam is a pulsed light beam, where the second light beam is a continuous-wave light beam; generating the first light beam; generating the second light beam; coupling the first and second light beams into the hollow core fiber; and propagating the first and second light beams through the hollow core fiber.

In embodiments, the techniques described herein relate to a method, where designing the hollow core fiber to guide the first light beam and the second light beam via optical antiresonance includes determining a distribution of antiresonant structures providing guiding of the first light beam and the second light beam within one or more performance metrics.

In embodiments, the techniques described herein relate to a method, where at least one the one or more performance metrics includes an optical mode profile of at least one of the first light beam or the second light beam.

In embodiments, the techniques described herein relate to a method, where at least one the one or more performance metrics includes a ratio of overlap between optical modes of at least one of the first light beam or the second light beam with antiresonant (AR) structures relative to hollow regions.

In embodiments, the techniques described herein relate to a method, where at least one the one or more performance metrics includes a propagation loss of at least one of the first light beam or the second light beam.

In embodiments, the techniques described herein relate to a method, where designing the hollow core fiber to guide the first light beam and the second light beam via optical antiresonance includes determining at least one of a core size of the hollow core fiber, a number of antiresonant (AR) structures, shapes of the AR structures, thicknesses of the AR structures, or positions of the AR structures providing guiding of the first light beam and the second light beam within one or more performance metrics.

In embodiments, the techniques described herein relate to a method, where the first and second light beams have overlapping spectra.

In embodiments, the techniques described herein relate to a method, where designing the hollow core fiber to guide the first light beam and the second light beam via optical antiresonance includes designing the hollow core fiber to guide the first light beam and the second light beam within a common transmission window.

In embodiments, the techniques described herein relate to a method, where the first and second light beams have different spectra.

In embodiments, the techniques described herein relate to a method, where designing the hollow core fiber to guide the first light beam and the second light beam via optical antiresonance includes designing the hollow core fiber to guide the first light beam within a first transmission window; and designing the hollow core fiber to guide the second light beam within a second transmission window.

In embodiments, the techniques described herein relate to a method, where coupling the first and second light beams into the hollow core fiber includes simultaneously coupling the first and second light beams into the hollow core fiber.

In embodiments, the techniques described herein relate to a method, where coupling the first and second light beams into the hollow core fiber includes selectively coupling one of the first light beam or the second light beam into the hollow core fiber.

In embodiments, the techniques described herein relate to a system including one or more light sources configured to generate two or more light beams, where at least one of the two or more light beams includes at least one wavelength below 450 nanometers, where at least one of the two or more light beams includes at least one wavelength above 2000 nanometers; a hollow core optical fiber configured to propagate the two or more beams; and one or more optical elements to couple the two or more light beams into the hollow core fiber.

In embodiments, the techniques described herein relate to a system, where at least one of the two or more light beams includes a laser beam.

In embodiments, the techniques described herein relate to a system, where the hollow core optical fiber is configured to guide at least one of the two or more light beams as a single-mode beam.

In embodiments, the techniques described herein relate to a system, where the two or more light beams have overlapping spectra.

In embodiments, the techniques described herein relate to a system, where the two or more light beams have different spectra.

In embodiments, the techniques described herein relate to a method including designing a hollow core fiber to guide two or more light beams via optical antiresonance, where at least one of the two or more light beams includes at least one wavelength below 450 nanometers, where at least one of the two or more light beams includes at least one wavelength above 2000 nanometers; generating the two or more light beams; coupling at least one of the two or more light beams into the hollow core fiber; and propagating the at least one of the two or more light beams through the hollow core optical fiber.

In embodiments, the techniques described herein relate to a method, where designing the hollow core fiber to guide two or more light beams via optical antiresonance includes determining a distribution of antiresonant structures providing guiding of the two or more light beams within one or more performance metrics.

In embodiments, the techniques described herein relate to a method, where at least one the one or more performance metrics includes an optical mode profile of at least one of the two or more light beams.

In embodiments, the techniques described herein relate to a method, where at least one the one or more performance metrics includes a ratio of overlap between optical modes of at least one of the two or more light beams with antiresonant (AR) structures relative to hollow regions.

In embodiments, the techniques described herein relate to a method, where the two or more light beams have overlapping spectra.

In embodiments, the techniques described herein relate to a method, where designing the hollow core fiber to guide the two or more light beams via optical antiresonance includes designing the hollow core fiber to guide the two or more light beams within a common transmission window.

In embodiments, the techniques described herein relate to a method, where the two or more light beams have different spectra.

In embodiments, the techniques described herein relate to a method, where designing the hollow core fiber to guide the two or more light beams via optical antiresonance includes designing the hollow core fiber to guide at least one of the two or more light beams within a first transmission window; and designing the hollow core fiber to guide at least one additional of the two or more light beams within a second transmission window.

In embodiments, the techniques described herein relate to a method, where designing the hollow core fiber to guide the two or more light beams via optical antiresonance includes determining at least one of a core size of the hollow core fiber, a number of antiresonant (AR) structures, shapes of the AR structures, thicknesses of the AR structures, or positions of the AR structures providing guiding of the two or more light beams within one or more performance metrics.

In embodiments, the techniques described herein relate to a method, where coupling at least one of the two or more light beams into the hollow core fiber includes simultaneously coupling at least two of the two or more light beams into the hollow core fiber.

In embodiments, the techniques described herein relate to a method, where coupling at least one of the two or more light beams into the hollow core fiber includes selectively coupling at least one of the two or more light beams into the hollow core fiber.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1 is a block diagram of a system providing selective or simultaneous delivery of two or more light beams with disparate properties via a HCF, in accordance with one or more embodiments of the present disclosure.

FIG. 2A is a simplified cross-sectional view of one non-limiting design of an HCF, in accordance with one or more embodiments of the present disclosure.

FIG. 2B is a simplified cross-sectional view of an HCF with multiple sets of AR structures having different characteristics, in accordance with one or more embodiments of the present disclosure.

FIG. 3 is a flow diagram illustrating steps performed in a method, in accordance with one or more embodiments of the present disclosure.

FIG. 4 is a flow diagram illustrating steps performed in a method, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods utilizing a single antiresonant hollow core fiber (referred to herein as an HCF) to deliver laser energy with different characteristics such as, but not limited to, different combinations of wavelength, pulse duration, power, or intensity. The systems and methods disclosed herein may enable the selective or simultaneous transmission of a wide variety of light sources through a common (e.g., a single) HCF as a delivery fiber in a way that is beyond the capabilities of traditional optical fiber technologies. The systems and methods disclosed herein may thus be applicable to a wide range of applications including, but not limited to, laser machining, laser materials processing, directed energy, medical technologies, or power beaming.

Typical optical fibers are formed as solid-core devices with solid core and cladding regions. In this configuration, light transmitted through the fiber propagates through the core and/or the cladding regions. It is contemplated herein that traditional optical fibers are designed for specific regimes of light and are inherently limited in power handling and/or wavelength capability due to various constraints such as, but not limited to, material properties or design requirements.

For example, typical solid-core optical fibers may be ill-suited or incapable of selectively or simultaneously delivering high-power continuous-wave (CW) and/or pulsed laser light. The maximum achievable power (or intensity) of transmitted light through a solid-core fiber is generally limited by the optical mode size, absorption characteristics of the fiber for wavelengths of interest, a damage threshold of the associated materials, and/or thresholds for undesired non-linear effects in the associated materials. For this reason, scaling the achievable power delivery for CW light in traditional solid-core fibers typically requires increasing a diameter of the core and/or cladding regions, which may generally lead to a multi-mode beam rather than a single-mode beam. However, such size scaling may limit the utility of such a fiber for alternative types of laser beams such as, but not limited to, pulsed beams (e.g., beams having pulse durations on the order of microseconds, nanoseconds, picoseconds, femtoseconds, or the like). For instance, it may typically be desirable for many applications to provide such pulsed beams as single-mode beams to provide high focused intensities suitable for inducing non-linear effects when focused outside the fiber. As a result, typical solid-core fibers with core sizes suitable for high-power CW laser light may be unsuitable for delivering single-mode pulsed light, while typical solid-core fibers with core sizes suitable for delivering single-mode pulsed laser light may be unsuitable for delivering high-power CW laser light over distances larger than a few meters.

As another example, typical solid-core optical fibers may generally be unsuitable for delivering light in different spectral ranges (e.g., light in a combination of ultraviolet (UV), visible, infrared (IR), near-IR, mid-IR, or far-IR spectral regions) due to material absorption. For instance, typical materials used to fabricate solid-core materials have absorption bands in at least some spectral regions that generally limit the ability to transmit light over a diverse range of spectral regions.

In contrast, HCFs are designed with a hollow core filled with gas or vacuum such that light is almost exclusively guided in this hollow core. In this way, the overlap of the optical mode of guided light with the material forming the HCF is exceedingly small. For example, some HCF designs may provide that the overlap of the optical mode of guided light with the material forming the HCF is on the order of 1% or less. The power and/or wavelength capabilities are thus almost exclusively based on the properties of air rather than the material used to form the fiber.

HCFs are thus well-suited for use as a delivery fiber suitable for selective and/or simultaneous transmission of light with different characteristics such as, but not limited to, wavelength, pulse duration, power, or intensity.

In some embodiments, a system includes an HCF for selective and/or simultaneous transmission of CW laser light (e.g., high-power laser light) and pulsed light. For example, such a system may include multiple laser sources providing CW and pulsed laser light and coupling optics suitable for coupling the light from the multiple laser sources into the HCF. It is contemplated herein that such a system may beneficially support single-mode pulsed laser light and higher powers of CW laser light than typical solid-core optical fibers.

In some embodiments, a system includes an HCF for selective and/or simultaneous transmission of laser light in different spectral regions (e.g., UV, visible, IR, mid-IR, far-IR, or the like). In particular, such a system may beneficially support any wavelength or combination of wavelengths that are transmissible in the hollow core (e.g., having absorption in the hollow core below a selected threshold) and further contemplated that this range of wavelengths is generally larger than achievable in any solid-core optical fiber. In general, the supported wavelengths that can be transmitted are defined by the design of the HCF being used.

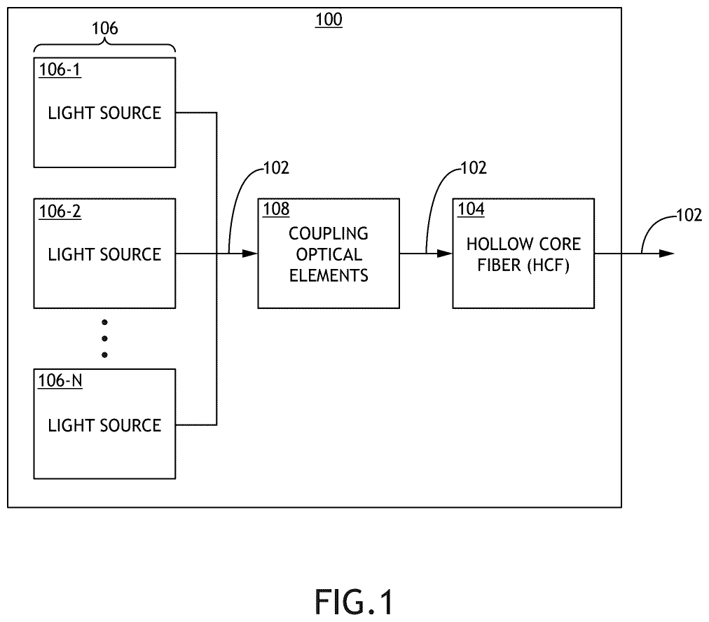

Referring now to FIGS. 1-4, systems and methods for selective or simultaneous delivery of laser light with disparate properties in a single HCF is described in greater detail, in accordance with one or more embodiments of the present disclosure.

FIG. 1 is a block diagram of a system 100 providing selective or simultaneous delivery of two or more light beams 102 with disparate properties via a HCF 104, in accordance with one or more embodiments of the present disclosure.

In some embodiments, the system 100 includes one or more light sources 106 to generate the light beams 102. For example, FIG. 1 depicts a configuration of the system 100 with N light sources 106 labeled 106-1 through 106-N. A light source 106 may include any source of light known in the art suitable for generating a light beam 102 such as, but not limited to, a laser source, a light emitting diode (LED), a lamp source, or the like.

A light beam 102 generated by a light source 106 may have any spectral content (e.g., wavelength or range of wavelengths) including, but not limited to, UV, visible, IR, mid-IR, or far-IR wavelengths. In some embodiments, a light beam 102 is a narrowband beam having a relatively narrow bandwidth centered around a center wavelength. For example, a narrowband beam may have, but is not required to have a bandwidth on the order of nanometers or lower. As an illustration, a light beam 102 may have a bandwidth (e.g., a linewidth) of less than 1 nanometer. In some embodiments, a light beam 102 is a broadband beam having a relatively large bandwidth. For example, a light beam 102 may have a continuous or non-continuous bandwidth including wavelengths in any spectral range including, but not limited to, UV, visible, IR, mid-IR, or far-IR wavelengths.

A light beam 102 generated by a light source 106 may have any amount of spatial and/or temporal coherence. For example, a laser light beam 102 may have a temporal coherence that is longer than a length of the HCF 104 such that an output beam from the HCF 104 may be temporally coherent.

A light beam 102 generated by a light source 106 may be a CW beam or a pulsed beam. A pulsed light beam 102 may include one or more pulses with any pulse duration (e.g., femtosecond pulses, picosecond pulses, nanosecond pulses, microsecond pulses, or the like). Such pulses may further be provided as a single pulse or a sequence of pulses with a selected repetition rate or with a selected pattern of inter-pulse spacings.

In some embodiments, the system 100 further includes various coupling optical elements 108 to couple two or more light beams 102 into a single HCF 104. The coupling optical elements 108 may include any components or combination of components suitable for coupling multiple light beams 102 into a single HCF 104 and may include, but are not limited to, beamsplitters, dichroic mirrors, fiber cladding light strippers, or fiber end caps.

In some embodiments, the light sources 106 and/or the coupling optical elements 108 are configured to provide simultaneous coupling of two or more light beams 102 into the HCF 104 for simultaneous delivery. In some embodiments, the light sources 106 and/or the coupling optical elements 108 are configured to selectively couple any combination of the two or more available light beams 102 to the HCF 104. In this way, the system 100 may selectively deliver any of the available light beams 102 using a common HCF 104. For example, the light sources 106 and/or the coupling optical elements 108 may include one or more shutters of any type to selectively block or transmit any of the various light beams 102.

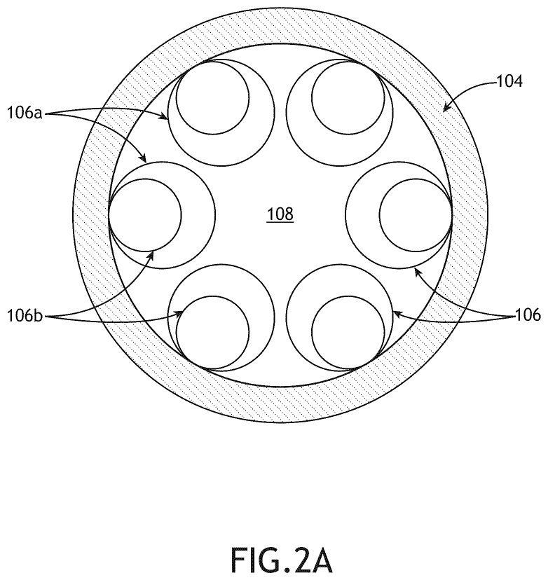

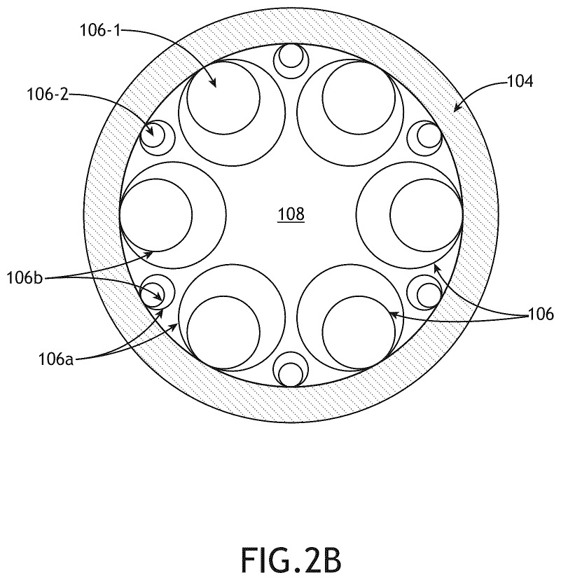

Referring now to FIGS. 2A-2B, various aspects of the HCF 104 are described in greater detail, in accordance with one or more embodiments of the present disclosure.

The HCF 104 may include any type of antiresonant HCF suitable for propagating the two or more light beams 102. In a general sense, an HCF 104 may include one or more materials arranged in the form of a fiber in which a cross-section of a core is substantially formed from air. Non-limiting examples of designs of an HCF 104 are provided in U.S. Provisional Patent Application 63/465,716 filed on May 11, 2023, U.S. Provisional Patent Application 63/465,762 filed on May 11, 2023, and U.S. Provisional Patent Application 63/470,560 filed on Jun. 2, 2023; Md. Selim Habib, et al., “Single-mode, low loss hollow-core anti-resonant fiber designs,” Opt. Express 27, 3824-3836 (2019); Matthew A. Cooper, et al., “600 W Single Mode CW Beam Delivery via Anti-Resonant Hollow Core Fiber”, J. Directed Energy 7, 222 (2022); Matthew A. Cooper, et al., “KW single mode CW laser transmission in an anti-resonant hollow-core fiber”, Proc. SPIE PC12092, Laser Technology for Defense and Security XVII, PC120920C (30 May 2022); and Matthew A. Cooper, et. al., “2.2 KW Single-Mode Narrow-Linewidth Laser Delivery Through a Hollow-Core Fiber”, Optica 10, 1253 (2023); all of which are incorporated herein by reference in their entireties. Further, the HCF 104 may be formed from any suitable material including, but not limited to, silica (e.g., doped or undoped), germanate glass, telluride glass, halide glass, or chalcogenide glass.

FIGS. 2A-2B depict two non-limiting illustrations of an HCF 104, in accordance with one or more embodiments of the present disclosure.

An HCF 104 may include a cladding structure 202 with a tubular shape and various antiresonant (AR) structures 204 within an interior of the cladding structure 202 designed to provide guiding in a hollow (e.g., gas-filled) central core 206. For example, the AR structures 204 may be formed as thin-walled AR elements extending longitudinally along a length of the the HCF designed to guide light within the hollow central core 206 through optical anti-resonance. This combination of thin-walled AR structures 204 and the associated optical anti-resonance results in a light intensity distribution almost entirely within hollow regions of the HCF 104 such that the overlap between guided light and the AR structures 204 is exceedingly small. As an illustration, some HCF 104 designs may provide an overlap between between guided light and the AR structures 204 in a range of 3-5%, whereas other HCF 104 designs may provide overlap of 1% or lower. More generally, the distribution of light within the HCF 104 may be impacted by the specific design of the AR structures 204 as well as bending of the HCF 104.

An HCF 104 may have any number or distribution of AR structures 204 suitable for guiding light through optical anti-resonance. In some embodiments, AR structures 204 are formed as hollow tubular structures with a circular or elliptical outer cross-section, where at least a portion of the walls have thicknesses designed to produce optical anti-resonant effects. For example, such AR structures 204 may be distributed around and attached to an interior perimeter of the cladding structure 202. In this configuration, the AR structures 204 may provide negative curvature elements that define the hollow central core 206. In some embodiments, an HCF 104 includes one or more sets of nested AR structures 204, where a set of nested AR structures 204 includes at least one AR structure 204 located in an interior region of another AR structure 204 (e.g., within a hollow region of another tubular AR structure 204). It is contemplated herein that such nested AR structures 204 may enhance the optical antiresonance effects relative to designs without nesting, which may promote strong confinement of light within the hollow central core 206 and low overlap between guided light and the material forming the AR structures 204.

An HCF 104 may include any type of cladding structure 202 suitable for enclosing the AR structures 204. In some embodiments, the cladding structure 202 includes one or more tubular structures (e.g., one or more layers of material forming a tubular structure), where the AR structures 204 lie within an interior region of the cladding structure 202. In some embodiments, the cladding structure 202 includes one or more additional smaller structures, which may be filled or hollow.

An HCF 104 may include additional elements (e.g., support structures) designed to position the AR structures 204 within the interior region of the cladding structure 202, which may impact the distribution of light within the HCF 104. For example, an HCF 104 may include one or more support structures between the cladding structure 202 and an AR structure 204. As another example, an HCF may include one or more support structures to position one AR structure 204 within another AR structure 204 (e.g., in a nested configuration). Further, such support structures may further provide antiresonance (e.g., be AR structures 204 themselves) or may be larger features that do not substantially provide antiresonance but serve to position AR structures 204.

FIG. 2A is a simplified cross-sectional view of one non-limiting design of an HCF 104, in accordance with one or more embodiments of the present disclosure. In FIG. 2A, the AR structures 204 include a series of first AR structures 204a formed as thin-walled AR elements extending attached to the perimeter of the cladding structure 202 and a set of second AR structures 204b nested within the first AR structures 204a. In this way, the HCF 104 includes a set of six nested AR structures 204 distributed around an interior perimeter of the cladding structure 202.

FIG. 2B is a simplified cross-sectional view of an HCF 104 with multiple sets of AR structures 204 having different characteristics, in accordance with one or more embodiments of the present disclosure. In particular, FIG. 2B depicts a design of an HCF 104 including a first set of AR structures 204-1 having first dimensions and a second set of AR structures 204-2 having second dimensions. In this configuration, both of the first set of AR structures 204-1 and the second set of hollow structures 204-2 include nested sets of first AR structures 204a and second AR structures 204b, but where the outer sizes first AR structures 204a are larger than for the second AR structures 204b. It is contemplated herein that the HCF 104 depicted in FIG. 2B may have relatively low losses even when the HCF 1041 is bent (e.g., may have relatively low microbending and/or macrobending losses).

It is to be understood that FIGS. 2A-2B are provided solely for illustrative purposes and should not be interpreted as limiting the scope of the present disclosure. Rather, the HCF 104 may generally have any design suitable for guiding light within the hollow central core 206. For example, an HCF 104 may include any number of AR structures 204 (or nested sets of AR structures 204) distributed around the inner perimeter of the cladding structure 202 such as, but not limited to, 2, 3, 4, 5, 6, 7, 8, or more AR structures 204 (or nested sets of AR structures 204).

It is contemplated herein that an HCF 104 may be fabricated such that various different wavelengths of light can be transmitted at the same time, with a substantially higher damage threshold and therefore higher levels of power can be transmitted. Further, an HCF 104 may support long wavelengths that would otherwise be absorbed in traditional solid-core optical fibers since a mode overlap of a light beam 102 with material forming the HCF 104 may be low (e.g., 1% or lower in some cases). In particular, HCFs 104 have been proven to be highly capable in the transmission of optical wavelengths in the UV, visible, NIR, and MIR regimes. They have also been shown to be able to transmit pulsed light utilizing pulse widths in the nanosecond, picosecond, and femtosecond ranges.

It is further contemplated herein that an HCF 104 may be suitable for transmitting a high-power CW light beam 102. For example, the HCF 104 may be suitable for transmitting one or more light beams 102 with powers greater than 10 W, greater than 500 W, greater than 1000 W, or the like.

High-power CW beam delivery is generally described in Matthew Cooper, et al., “600 W Single Mode CW Beam Delivery via Anti-Resonant Hollow Core Fiber,” Journal of Directed Energy, vol. 7, no. 2, 2022; and Matthew Cooper, et al., “KW single mode CW laser transmission in an anti-resonant hollow-core fiber”, Proc. SPIE PC12092, Laser Technology for Defense and Security XVII, PC120920C (30 May 2022); both of which are incorporated herein by reference in their entireties.

Various non-limiting configurations and/or operational states of the system 100 are described in greater detail, in accordance with one or more embodiments of the present disclosure.

Low loss transmission of high energy laser light while preserving the spatial and spectral characteristics of that light is critical in many industrial and scientific areas such as, but not limited to, optical communications, industrial machining/fabrication, laser material processing, or directed energy. In these applications, there are many aspects of the light such as the wavelength, polarization, spatial structure, and temporal properties (pulse duration) which can drastically affect the effectiveness or use case of a particular interest. For many cases, transmission via optical fiber is the preferred mechanism.

Further, many applications within the defense and commercial sectors utilize high-energy versions of these laser sources for widespread applications, but it is common for the delivery mechanism of those sources to be specially designed for that specific source. This limits the capability to utilize multiple different high-energy sources in the same space where it might be needed due to the space requirement of housing multiple different laser system output couplers.

The system 100 disclosed herein may include a delivery fiber including a single HCF 104 to eliminates the requirement of multiple high-energy delivery apparatuses by multiplexing and transmitting all the required energy (e.g., the associated two or more light beams 102) through the single HCF 104 for delivery.

In some embodiments, the system 100 includes an HCF 104 configured to selectively or simultaneously deliver both one or more CW light beams 102 (e.g., high-power CW laser light) and one or more pulsed light beams 102, where any of the light beams 102 may be, but are not required to be laser light beams 102. For example, the system 100 may include two or more light sources 106 providing CW and pulsed light beams 102 and associated coupling optical elements 108 suitable for coupling the light beams 102 into the HCF 104. It is contemplated herein that such a configuration may beneficially simultaneously support single-mode pulsed light beams 102 and higher powers of CW light beams 102 than achievable with typical solid-core optical fibers.

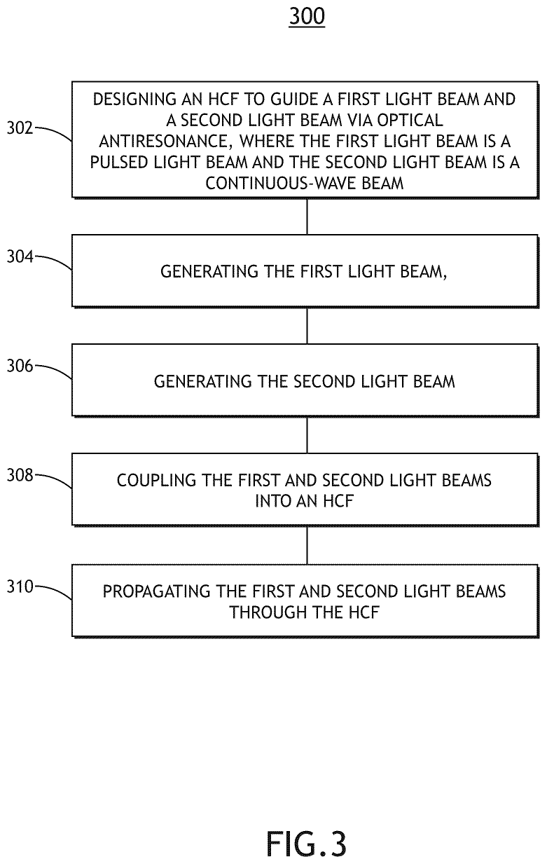

FIG. 3 is a flow diagram illustrating steps performed in a method 300, in accordance with one or more embodiments of the present disclosure. Applicant notes that the embodiments and enabling technologies described previously herein in the context of the system 100 should be interpreted to extend to the method 300. It is further noted, however, that the method 300 is not limited to the architecture of the system 100.

In some embodiments, the method 300 includes a step 302 of designing an HCF 104 to guide a first light beam 102-1 and a second light beam 102-2 via optical antiresonance, where the first light beam 102-1 is a pulsed light beam (e.g., one or more pulses of light) and the second light beam 102-2 is a CW beam. The pulsed first light beam 102-1 and the CW second light beam 102-2 may have any suitable characteristics. For example, the pulsed first light beam 102-1 may have pulse durations on the order of nanoseconds, picosecond, femtoseconds, or shorter. As another example, the CW second light beam 102-2 may have average powers of 10 W, 500 W, 1000 W, or greater. In any case, the power of either beam may be limited by absorption in AR structures 204, which may depend on the overlap of the associated optical modes with the AR structures as described in greater detail below.

The step 302 may be implemented by determining a distribution of AR structures 204 providing guiding of the first light beam 102-1 and the second light beam 102-2 within one or more performance metrics. The performance metrics may include any selected metric describing the propagation of the first light beam 102-1 and/or the second light beam 102-2 within the HCF 104.

For example, a performance metric may include a transverse mode profile metric defining a number or type of optical modes associated with the associated beam in the HCF 104. As an illustration, the step 302 may include designing the HCF 104 to provide that at least the second light beam 102-2 is guided as a single transverse mode beam. Ensuring single-mode guiding for at least the pulsed second light beam 102-2 may allow for tight focusing of the second light beam 102-2 after exiting the HCF 104. In this configuration, the CW first light beam 102-1 may be guided as a single transverse mode beam or a multi-mode beam. In some applications, it may be desirable that the first light beam 102-1 and the second light beam 102-2 have similar mode profiles and/or mode size distributions. In some applications, the first light beam 102-1 and the second light beam 102-2 may have different mode profiles and/or mode size distributions. As a result, an HCF 104 may be tailored for different applications.

As another example, a performance metric may include an overlap between the first light beam 102-1 and/or the second light beam 102-2 with material forming the AR structures 204. The overlap may be quantified using any suitable technique such as, but not limited to, a ratio of overlap between the optical modes (e.g., transverse modes) with the material forming the AR structures 204 relative to hollow regions. The overlap for the first light beam 102-1 and/or the second light beam 102-2 may generally have any suitable values. For instance, the overlap for the first light beam 102-1 and/or the second light beam 102-2 may be lower than 5% and in some cases vanishingly low (e.g., on the order of 1×10⁻⁴%). In some embodiments, the overlap is lower than 1%, which may be suitable for many applications.

In a general sense, it may be desirable to reduce the overlap between the optical modes with the AR structures 204 to reduce absorption, undesirable dispersion effects, or the like. However, it may be the case that certain applications allow different overlap performance metrics for the first light beam 102-1 and/or the second light beam 102-2. As an illustration, in some embodiments, an overlap performance metric associated with a pulsed first light beam 102-1 may be lower (e.g., indicative of less overlap) than for a CW second light beam 102-2.

As another example, a performance metric may include a dispersion profile in wavelengths of interest for the first light beam 102-1 and/or the second light beam 102-2. Dispersion may be quantified using any suitable metric such as, but not limited to mode index as a function of wavelength. As an illustration, it may be desirable to provide a relatively flat dispersion profile for wavelengths of interest (e.g., wavelengths associated with a pulsed beam). As another illustration, if both the first light beam 102-1 and the second light beam 102-2 are pulsed, it may be desirable for such pulses to be temporally synchronized at an output of the system 100.

The step 302 may include adjusting any aspects of the AR structures 204 to provide desired performance metrics for the first light beam 102-1 and the second light beam 102-2. For example, the step 302 may include adjusting aspects of the AR structures 204 such as, but not limited to, the core size (e.g., defined by an outer dimension of AR structures 204 or nested sets thereof, thicknesses of the AR structures 204 (e.g., related to antiresonant effects), shapes of AR structures 204 (e.g., elements formed as circular tubes, elliptical tubes, tubes with asymmetric wall thicknesses, or the like), a number of AR structures 204 forming the hollow central core 206, a number of AR structures 204 within nested sets of AR structures 204, or positions of any AR structures 204. As an illustration, the core size (e.g., a size of the hollow central core 206 influenced by a number and size of AR structures 204 bounding this hollow central core 206) may have a significant impact on an overlap performance metric, where larger core sizes may decrease overlap. The use of nested AR structures 204 may also reduce overlap for a given core size.

It is contemplated herein that any such aspects of the AR structures 204 may provide interrelated impacts on multiple performance metrics associated with the first light beam 102-1 and/or the second light beam 102-2 such that such aspects may be balanced in step 302 to provide tailored properties for both the first light beam 102-1 and the second light beam 102. For instance, thicknesses of AR structures 204 (e.g., wall thicknesses) may impact both the antiresonant performance as a function of wavelength (e.g., dispersion characteristics) as well as overlap.

As an illustration, performance metrics associated with dispersion may be selected in step 302 to be more stringent for a pulsed first light beam 102-1 than for a CW second light beam 102-1. It is contemplated herein that dispersion performance metrics may be particularly critical for a pulsed first light beam 102-1 since these parameters may significantly impact properties of transmitted pulses (e.g., pulse length), whereas such performance metrics may be less significant for a CW second light beam 102-2 so long as physical damage to the HCF 104 is avoided. In particular, it may be desirable to have relatively stable or flat dispersion for wavelengths associated with a pulsed first light beam 102-1 (e.g., relatively flat losses for the wavelengths of the pulsed first light beam 102-1), whereas a CW second light beam 102-2 may have a narrow linewidth and thus may only require relatively low loss at a particular wavelength. As a result, the AR structures 204 may be designed with stricter tolerances for performance metrics associated with dispersion for a pulsed first light beam 102-1 over a CW second light beam 102-2.

In a general sense, the first light beam 102-1 and the second light beam 102-2 may have the same or different wavelengths (or spectra more generally). In some embodiments, the first light beam 102-1 and the second light beam 102-2 have overlapping wavelengths (or spectra). In some embodiments, the first light beam 102-1 and the second light beam 102-2 have non-overlapping spectra.

For some designs of an HCF 104, resonance wavelengths (e.g., wavelengths at which losses are high) may be described by:

$${λ}_{m} = \frac{2 t \sqrt{{n}^{2} - 1}}{m} , \qquad ( 1 )$$

where λ represents wavelength, m represents resonance number and is a positive integer, t represents a thickness of AR structures 204 (e.g., wall thicknesses), and n represents refractive index of the material forming the AR structures 204. In this way, the wavelength ranges between resonant wavelengths may correspond to transmission windows suitable for guiding of light through antiresonance. However, it is to be understood that equation (1) is provided merely for illustrative purposes and should not be interpreted as limiting the scope of the present disclosure. For example, equation (1) focuses on a single thickness t. Applications including AR structures 204 with different thicknesses (e.g., nested sets of AR structures 204 with different thicknesses) may be governed by a different equation. However, one of ordinary skill in the art could extend the teachings herein to alternative designs of an HCF 104 such that these alternative designs are within the spirit and scope of the present disclosure.

In some embodiments, the AR structures 204 are designed in step 302 such that the first light beam 102-1 and the second light beam 102-2 lie within a common transmission window (e.g., between a set of two resonance peaks). Such a configuration may be suitable for, but is not limited to, applications in which the first light beam 102-1 and the second light beam 102-2 have overlapping or at least similar wavelengths. In some embodiments, the AR structures 204 are designed in step 302 such that the first light beam 102-1 and the second light beam 102-2 lie within different transmission windows (e.g., between different sets of resonance peaks).

In some embodiments, the method 300 includes a step 304 of generating the first light beam 102-1. In some embodiments, the method 300 includes a step 306 of generating the second light beam 102-2. In some embodiments, the method 300 includes a step 308 of coupling the first and second light beams 102 into an HCF 104. In some embodiments, the method 300 includes a step 310 of propagating the first and second light beams 102 through the HCF 104.

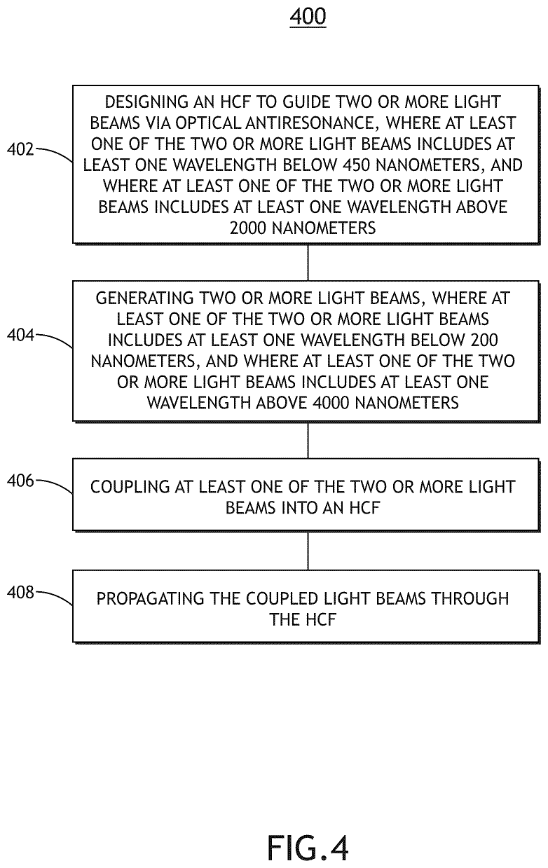

Referring now to FIG. 4, in some embodiments, the system 100 includes an HCF 104 configured to selectively or simultaneously deliver two or more light beams 102 including wavelengths in different spectral regions (e.g., UV, visible, IR, mid-IR, far-IR, or the like). In particular, it is contemplated herein such a configuration may beneficially support any wavelength or combination of wavelengths that are transmissible in an air core of an HCF 104 (e.g., above a selected threshold) and further contemplated that this range of wavelengths is generally larger than achievable in any typical solid-core optical fiber.

FIG. 4 is a flow diagram illustrating steps performed in a method 400, in accordance with one or more embodiments of the present disclosure. Applicant notes that the embodiments and enabling technologies described previously herein in the context of the system 100 should be interpreted to extend to the method 400. It is further noted, however, that the method 400 is not limited to the architecture of the system 100.

In some embodiments, the method 200 includes a step 402 of designing an HCF 104 to guide two or more light beams 102 via optical antiresonance, where at least one of the two or more light beams 102 includes at least one wavelength below 450 nanometers, and where at least one of the two or more light beams 102 includes at least one wavelength above 2000 nanometers. It is contemplated herein that it may impossible or impractical to provide simultaneous guiding of such wavelengths (or wavelength ranges) with a typical solid-core fiber, but that the method 400 may be used to develop an HCF 104 to provide efficient guiding of such wavelengths (or wavelength ranges).

The description associated with step 302 of method 300 may be extended to apply to the step 402 of the method 400. For example, the step 402 may include determining a distribution of AR structures 204 providing guiding of the two or more light beams 102, where performance metrics associated with each of the two or more light beams 102 may be independently tuned, controlled, or weighted. Further, the description of the performance metrics, the aspects of the AR structures 204 that may be controlled, and the impacts of tuning the AR structures 204 above also apply to step 402. In particular, equation (1) and the associated description may be extended to step 402. In this way, an HCF 104 may be designed to provide one or more selected transmission windows (e.g., wavelength ranges between resonance peaks) such that known wavelengths (or spectra) of the two or more light beams 102 may be distributed between any of the transmission windows.

Further, the two or more light beams 102 associated with the method 400 may include any combination of pulsed or CW beams. In this way, discussions of performance metrics associated with pulsed and CW beams may be extended to step 402 of the method 400.

In some embodiments, the method 200 includes a step 404 of generating two or more light beams 102, where at least one of the two or more light beams 102 includes at least one wavelength below 450 nanometers, and where at least one of the two or more light beams 102 includes at least one wavelength above 2000 nanometers. In some embodiments, the method 400 includes a step 406 of coupling at least one of the two or more light beams 102 into an HCF 104. In some embodiments, the method 400 includes a step 408 of propagating the coupled light beams 102 through the HCF 104.

Various non-limiting applications are now described in accordance with one or more embodiments of the present disclosure.

In some embodiments, the systems or methods disclosed herein are used for industrial materials processing or laser processing more generally. As an illustration, it is common in the industrial sector to use a multi-kilowatt highly multi-mode continuous wave (CW) fiber laser for the machining of a large sheet metal or other such structures. In a different but similar scenario, one can increase the precision of the cuts in the fabrication of metal via the use of a multi-kilowatt single-mode continuous wave fiber laser. However, such single-mode CW laser sources are generally unable to achieve the same output powers as a multi-mode CW counterpart based on currently-available technologies.

Further, delivery of high energy laser pulses with duration in the nanosecond to femtosecond regime may be beneficial for some applications. For instance, CW, quasi-CW, nanosecond, picosecond, and femtosecond laser sources offer different use cases in the industrial manufacturing sector. Picosecond and femtosecond pulses transfer a minimal amount of heating to the surface being manufactured with femtosecond pulses preferred for glass materials and picosecond pulses for metals. The ultra-short nature of the laser pulse directly ablates the material on the order of the spot size of the laser beam optics. This leads to precisely defined features in the materials with a resolution on the order of the minimal laser spot size of the optical system. Feature machining methods such as cutting, drilling, and micromachining are dependent on this methodology.

The minimum spot size achievable is contingent on the both the wavelength and the beam quality of the laser system. The poorer the beam quality or the longer the wavelength, the larger the associated minimum spot size. For example, a laser source with a 1.0 cm beam diameter at a wavelength of 532 nm (green laser light) can be focused down to a spot size of 6.77 um with a 100 mm focal length lens and a perfect beam quality factor of 1, whereas the same optical scenario will only achieve a spot size of 13.5 um at a wavelength of 1064 nm. One can also create a spot size of 13.5 um from the 532 nm light by degrading the beam and doubling the beam quality factor. One may argue that the smaller feature size is achievable by employing a system with a shorter laser wavelength, but the depth of focus for this system is a limiting factor for larger projects that warrant features sizes on the order of millimeters. If one instead uses a longer wavelength, then the time to completion is significantly reduced as both the spot size and the depth of focus is greatly increased.

Ultrashort pulse laser systems have very narrow pulses in time. Such pulses are particularly vulnerable to the transmission medium (e.g., by non-linear interactions between the ultrashort pulses and the transmission medium). As a result, such systems commonly utilize free-space optics to avoid optical fibers (e.g., traditional solid-core optical fibers) for delivery or may use relatively short delivery fibers (e.g., less than 2 m in length).

For applications such as welding, surface cleaning, and heat-treating, employing CW, Quasi-CW, and/or nanosecond pulsed lasers may be preferred because more absorption and heat is required or beneficial. Spot size and depth of focus are still a concern in these methods, but may not be as critical as the power applied. In these instances, single-mode high-power CW and quasi-CW are commonly used for precision welding while nanosecond pulsed sources can be used for cutting, welding, heat treating, and for surface finishing of metals.

As with other applications, the different sources of various wavelengths and pulse durations (CW, quasi-CW, nanosecond, picosecond, and femtosecond) all typically require independent delivery systems and apparatuses to deliver the optical energy of each system to the point of materials processing. If an application necessitates multiple different materials processing capabilities at a particular processing center, then typical techniques require multiple delivery apparatuses (e.g., one for each type of beam to be used). Further, each of these three types of laser sources may require specifically designed optical components or fibers to guide the laser light to the site of material interaction and therefore dedicated space for each tool.

In some embodiments, a single HCF 104 may operate as a delivery fiber for any combination of desired light beams 102 suitable for machining or materials processing. For example, a single HCF 104 may operate as a delivery fiber for any combination of high-power CW light beams 102 or pulsed light beams 102. Further, the light beams 102 may have any combination of wavelengths, power levels, or pulse durations.

It is contemplated herein that the systems and methods disclosed herein may reduce the complexity and equipment footprint. For example, with a combined delivery HCF 104, it is possible to develop a workstation capable of welding, cutting, resurfacing, and micromachining at multiple different wavelengths with a single high precision processing head. This would be a monumental change to the potential cost and equipment required for traditional laser machining processes that are taking over in all industry fronts.

In some embodiments, the systems or methods disclosed herein are used for additive manufacturing. For example, a basic principle of some additive manufacturing techniques is that a thin layer of hyper-spherical powdered material is laid across a build plate or bed, on which a manufactured structure may be additively fabricated. For instance, once the powder is laid out in a layer, the material may be preheated and then a high-power laser pulse may be used to sinter the desired spot size into a substrate. Once sintered, a nanosecond pulsed laser can then be applied to smooth out the surface roughness. By repeating this process across many layers, a three-dimensional structure can be formed with high accuracy. Further, specific material properties can be achieved that are not possible through traditional machining methods.

One of the current limitations in this process is the precise application of laser energy via multiple delivery mechanisms to facilitate the various steps such as, but not limited to, low power heating, high power sintering, and pulsed smoothing. The efficiency of heating and melting of the various metals and materials used for manufacturing greatly depends upon the absorption for each material, which is directly dependent on the wavelength of the light energy applied to the material. For ease of operation, many such systems utilize fiber-based laser sources that provide approximately 1 μm light. This allows for the delivery fiber to be spliced directly onto the output of the fiber laser which is fed to the manufacturing apparatus. However, this configuration may limit the available wavelengths to industry to those transmissible down a traditional fiber-based laser gain medium, and thus the material absorption may not be optimal.

One way to overcome these challenges is by multiplexing multiple sources (e.g., multiple sources with different wavelengths, power levels, and/or pulse durations suitable for different processing steps) through a single HCF 104 as disclosed herein. It is contemplated herein that the systems and methods disclosed herein may thus enable precise and predictable pointing accuracy for each laser source desired as well as allow for a single apparatus to machine numerous materials.

In some embodiments, the systems or methods disclosed herein are used for directed energy applications. For example, a single HCF 104 may be used to simultaneously transmit a multi-kW quasi single mode laser light beam 102 and a femtosecond laser light beam 102. As an illustration, it may be desirable to use different laser sources to simultaneously target, identify, track, and ultimately disable unfriendly targets.

For instance, the primary high-energy laser (HEL) in such a system traditionally relies on continuous wave (CW) narrow linewidth single mode laser light in order to propagate enough energy on the desired location that can span many kilometers away. The mechanism by which a target is incapacitated is via heat induced by the laser energy leading to catastrophic failure in the navigation sensor or in structural integrity of the target. Alternatively, femtosecond lasers are used extensively in industrial machining and manufacturing due to the precise nature of cutting, drilling, and engraving one can achieve in metals and other hard materials. The limiting factor in using a femtosecond laser as part of the primary HEL in DE is due to the challenge of propagating a high-energy femtosecond pulses along the same optical path as the supporting illuminating lasers.

However, it is contemplated herein that a single HCF 104 may simultaneously support both types of laser light with low attenuation of the beams. This allows for a dual HEL configuration utilizing both a CW and femtosecond pulse HELs following the same optical path through an HCF 104 beam director and onto the desired target location. In this example, the multi-kilowatt CW HEL light beam 102 may coupled into the HCF 104 near the light source 106. The coupling optical elements 108 may then include a dichroic mirror that allow the HEL light beam 102 to travel through while reflecting a second perpendicular HEL light beam 102 with a femtosecond pulse duration such that they become colinear and are coupled into the HCF 104. The HCF 104 may preserve the characteristics of both light beams 102. Further, the HCF 104 may route the light beams 102 to additional delivery optics that may be many meters away without degrading the light beams 102. Due to the colinear output of the light from the HCF 104, the two laser light beams 102 may follow the exact same optical path and may thus land simultaneously on the desired target location, which may be many kilometers away.

In some embodiments, the systems or methods disclosed herein are used for medical applications. For example, the medical industry has a use case for pulsed laser light spanning ultraviolet through the long-wave infrared (LWIR). As some illustrations, Lasik eye corrective surgery may be performed using Excimer laser light near 192 nm, some cancer treatments may utilize red light near 650 nm, and some laser scalpels function in the mid-IR and far-IR wavelengths.

It is contemplated herein that the use of typical solid-core optical fibers to deliver light from any combination of such sources with typical solid-core fibers may place significant restrictions on the pulse energy and wavelength of light that such a fiber can support. For example, solid-core silica fibers may support visible and near-infrared light, but become highly lossy for ultraviolet light and any wavelengths beyond than the near-infrared regime. As another example, fibers suitable for mid-IR and/or far-IR wavelengths may exhibit absorption for visible or UV light.

However, it is further contemplated herein that an HCF 104 may support the entire range of wavelengths associated with medical laser sources, which may eliminate the need for multiple laser delivery apparatuses. Rather, in some embodiments, light from various light sources 106 suitable for medical applications may be coupled (e.g., using coupling optical elements 108) into a single HCF 104 that may operate as a single delivery and pointing device. By delivering light beams 102 spanning multiple spectral ranges, it may be possible to conduct an entire surgical procedure (or multiple surgical procedures) with a single system 100. As a non-limiting illustration, a single system 100 may be used as a computer-controlled laser scalpel to clear the area on the patient via hair removal at 1,940 nm, perform soft tissue surgery at either 2,900 nm or 10,600 nm, then encourage healing near the surgical region by applying one or more light beams 102 at 450 nm, 650 nm, or 850 nm depending on the tissue and wound type.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A system comprising:
a first light source configured to generate a first light beam, wherein the first light beam is a pulsed light beam, wherein the first light beam is guided as a single transverse mode beam;
a second light source configured to generate a second light beam, wherein the second light beam is a continuous-wave light beam;
a hollow core fiber configured to propagate the first and second light beams; and
one or more optical elements to couple the first and second beams into the hollow core fiber.

2. The system of claim 1, wherein at least one of the first or second light beams comprises a laser beam.

3. The system of claim 1, wherein the hollow core optical fiber is configured to guide at least the second light beam as a single transverse mode beam.

4. The system of claim 3, wherein the first light beam has a power greater than approximately 10 W.

5. The system of claim 3, wherein the first light beam has a power greater than approximately 500 W.

6. The system of claim 3, wherein the first light beam has a power greater than approximately 1000 W.

7. The system of claim 1, wherein the first and second light beams have overlapping spectra.

8. The system of claim 7, wherein the first and second light beams have wavelengths within a common transmission window of the hollow core fiber.

9. The system of claim 1, wherein the first and second light beams have different spectra.

10. The system of claim 9, wherein the first light beam has wavelengths within a first transmission window of the hollow core fiber, wherein the second light beam has wavelengths with a second transmission window of the hollow core fiber.

11. The system of claim 1, wherein the first light beam includes one or more pulses with a duration less than approximately one microsecond.

12. The system of claim 1, wherein the first light beam includes one or more pulses with a duration less than approximately one nanosecond.

13. The system of claim 1, wherein the first light beam includes one or more pulses with a duration less than approximately one picosecond.

14. A method comprising:
designing a hollow core fiber to guide a first light beam and a second light beam via optical antiresonance, wherein the first light beam is a pulsed light beam, wherein the second light beam is a continuous-wave light beam;
generating the first light beam;
generating the second light beam;
coupling the first and second light beams into the hollow core fiber; and
propagating the first and second light beams through the hollow core fiber.

15. The method of claim 14, wherein designing the hollow core fiber to guide the first light beam and the second light beam via optical antiresonance comprises:
determining a distribution of antiresonant structures providing guiding of the first light beam and the second light beam within one or more performance metrics.

16. The method of claim 15, wherein at least one the one or more performance metrics comprises:
an optical mode profile of at least one of the first light beam or the second light beam.

17. The method of claim 15, wherein at least one the one or more performance metrics comprises:
a ratio of overlap between optical modes of at least one of the first light beam or the second light beam with antiresonant (AR) structures relative to hollow regions.

18. The method of claim 15, wherein at least one the one or more performance metrics comprises:
a propagation loss of at least one of the first light beam or the second light beam.

19. The method of claim 14, wherein designing the hollow core fiber to guide the first light beam and the second light beam via optical antiresonance comprises:
determining at least one of a core size of the hollow core fiber, a number of antiresonant (AR) structures, shapes of the AR structures, thicknesses of the AR structures, or positions of the AR structures providing guiding of the first light beam and the second light beam within one or more performance metrics.

20. The method of claim 14, wherein the first and second light beams have overlapping spectra.

21. The method of claim 20, wherein designing the hollow core fiber to guide the first light beam and the second light beam via optical antiresonance comprises:
designing the hollow core fiber to guide the first light beam and the second light beam within a common transmission window.

22. The method of claim 14, wherein the first and second light beams have different spectra.

23. The method of claim 22, wherein designing the hollow core fiber to guide the first light beam and the second light beam via optical antiresonance comprises:
designing the hollow core fiber to guide the first light beam within a first transmission window; and
designing the hollow core fiber to guide the second light beam within a second transmission window.

24. The method of claim 14, wherein coupling the first and second light beams into the hollow core fiber comprises:
simultaneously coupling the first and second light beams into the hollow core fiber.

25. The method of claim 14, wherein coupling the first and second light beams into the hollow core fiber comprises:
selectively coupling one of the first light beam or the second light beam into the hollow core fiber.

26-41. (canceled)
